(19) United States
(12) Patent Application Publication
(10) Pub. No.: US 2026/0228649 A1
(43) Pub. Date: Aug. 6, 2026

(54) REALTIME OFFER FEEDBACK SYSTEM

(71) Applicant: MFTB Holdco, Inc., Seattle, WA (US)

(72) Inventor: Matthew Fix, Seattle, WA (US)

(21) Appl. No.: 19/044,022

(22) Filed: Feb. 3, 2025

(51) Int. Cl. G06Q 10/04; G06Q 30/0283; G06Q 50/16

(52) U.S. Cl. CPC G06Q 10/04; G06Q 30/0283; G06Q 50/16

(57) ABSTRACT

A system and method for determining real estate offer strength is provided. The systems and methods described herein utilize a hybrid processing architecture that combines batch and real-time computations. The system maintains a cache of pre-computed probability at various offer ratios for concurrent property listings while enabling real-time updates in response to listing changes. A hierarchical model framework integrates automated valuation estimates, time-to-pending predictions, and offer distributions to generate win, outbid, and rejection probabilities.

### BACKGROUND

Existing online real estate listing systems may include automated valuation models (AVM) useable to calculate an estimated value of a home. Such models include highly complex analysis about the size, features, appearance, neighborhood, and trends regarding real estate sales for each listing for which such a valuation is generated. At the same time, although there may be a relationship between offer price and likelihood of offer acceptance, there is no guarantee that an offer meeting an AVM-generated valuation would be accepted.

Technical challenges in real estate offer analysis systems arise from the need to process and serve complex probabilistic predictions for millions of concurrent property listings while maintaining accuracy and responsiveness. While AVMs may pre-compute a valuation of a real estate listing, accurate assessment of offer strength requires an understanding of the offer being made, including offer parameters provided by a user in realtime. Traditional approaches using single global models or purely batch processing systems face significant limitations in providing timely, listing-specific insights.

### SUMMARY

In general terms, a system and method for determining real estate offer strength is provided. The systems and methods described herein utilize a hybrid processing architecture that combines batch and real-time computations. The system maintains a cache of pre-computed probabilities keyed by candidate offer amounts for concurrent property listings while enabling real-time updates in response to listing changes. A hierarchical model framework integrates automated valuation estimates, time-to-pending predictions, and offer distributions to generate win, outbid, and rejection probabilities.

In a first aspect, a computer-implemented method for determining real estate offer strength is provided. The method includes receiving, by one or more processors, listing data for a real estate property, and generating, by the one or more processors: estimated values for each of a plurality of real estate properties including the real estate property by a first model comprising an automated valuation model (AVM); time-to-pending predictions for the plurality of real estate properties including the real estate property by a second model comprising a time-to-pending model; and an offer probability distribution for the plurality of real estate properties including the real estate property at a third model comprising an offer distribution model. The method further includes combining, by the one or more processors, outputs of the first, second, and third models into a hierarchical framework by: estimating seller acceptance parameters consistent with the estimated values; and generating offer probability distributions aligned with the time-to-pending predictions and the estimated values. The method further includes performing, by the one or more processors, a series of simulations using the hierarchical framework including the offer probability distributions and seller acceptance parameters to determine, for each property, a plurality of probabilities including: a probability of offer acceptance; a probability of being outbid; and a probability of offer rejection. The method also includes caching, in memory, results of the series of simulations for each property in advance of receiving offer parameters from a user device, and, in response to receiving a set of offer parameters associated with the real estate property from the user device, calculating an offer strength based on the set of offer parameters and the cached results of the series of simulations. The method also includes providing, by the one or more processors, an indication of offer strength for display via a user interface in association with the real estate property.

In a second aspect, a system for providing realtime real estate offer strength feedback based on offer parameters associated with a real estate listing is provided. The system includes a server system that includes one or more processing units and a memory communicatively coupled to the one or more processing units storing an automated valuation model, a time-to-pending model, and an offer distribution model. The memory further stores instructions which, when executed, cause the one or more processing units to: receive listing data for a real estate property; generate estimated values for each of a plurality of real estate properties including the real estate property by the automated valuation model (AVM); generate time-to-pending predictions for the plurality of real estate properties including the real estate property by the time-to-pending model; and generate an offer probability distribution for the plurality of real estate properties including the real estate property at the offer distribution model; combine, outputs of the AVM, the time-to-pending model, and the offer distribution model into a hierarchical framework by estimating seller acceptance parameters consistent with the estimated values and generating offer probability distributions aligned with the time-to-pending predictions and the estimated values; perform a series of simulations using the hierarchical framework including the offer probability distributions and seller acceptance parameters to determine, for each property, a plurality of probabilities including a probability of offer acceptance, a probability of being outbid, and a probability of offer rejection; and cache, in memory, results of the series of simulations for each property in advance of receiving offer parameters from a user device. The instructions further cause the system to, in response to receiving a set of offer parameters associated with the real estate property from the user device, calculate an offer strength based on the set of offer parameters and the cached results of the series of simulations; and provide an indication of offer strength for display via a user interface in association with the real estate property.

In a third aspect, a computer-readable storage medium storing computer-executable instructions thereon which, when executed by a computing system, cause the computing system to perform a method for determining real estate offer strength. The method includes receiving, by one or more processors, listing data for a real estate property, and generating, by the one or more processors: estimated values for each of a plurality of real estate properties including the real estate property by a first model comprising an automated valuation model (AVM); time-to-pending predictions for the plurality of real estate properties including the real estate property by a second model comprising a time-to-pending model; and an offer probability distribution for the plurality of real estate properties including the real estate property at a third model comprising an offer distribution model. The method further includes combining, by the one or more processors, outputs of the first, second, and third models into a hierarchical framework by: estimating seller acceptance parameters consistent with the estimated values; and generating offer probability distributions aligned with the time-to-pending predictions and the estimated values. The method further includes performing, by the one or more processors, a series of simulations using the hierarchical framework including the offer probability distributions and seller acceptance parameters to determine, for each property, a plurality of probabilities including: a probability of offer acceptance; a probability of being outbid; and a probability of offer rejection. The method also includes caching, in memory, results of the series of simulations for each property in advance of receiving offer parameters from a user device, and, in response to receiving a set of offer parameters associated with the real estate property from the user device, calculating an offer strength based on the set of offer parameters and the cached results of the series of simulations. The method also includes providing, by the one or more processors, an indication of offer strength for display via a user interface in association with the real estate property.

### BRIEF DESCRIPTION OF THE DRAWINGS

FIG. 1 is a system architecture diagram illustrating the components of a real estate offer strength modeling system.

FIG. 2 is a flow diagram illustrating a model framework for a real estate property offer lifecycle, in accordance with an example implementation of the present disclosure.

FIG. 3 is a graph showing simulated offer outcomes across different candidate offer prices for a particular listing, in accordance with an example embodiment.

FIG. 4 is a process flow diagram for a method of modeling offer strength, showing a periodic updating process and real-time calculation components in accordance with an example embodiment.

FIG. 5 is a data flow diagram illustrating the interaction between time to pending data, property listings, automated valuation models and the offer strength calculation components to generate offer strength indicators as probabilities.

FIG. 6 depicts an example user interface of an offer strength analyzer showing offer price range, win probability, and local market conditions including market temperature and days on market metrics.

FIG. 7 shows another example user interface implementation with input controls for listing selection and offer amounts, along with market condition displays and probability outcome indicators.

FIG. 8 is a block diagram illustrating an example computing system with which aspects of the offer strength modeling system may be implemented.

### DETAILED DESCRIPTION

As briefly described above, embodiments of the present invention are directed to an offer strength analysis and feedback system operable to provide realtime feedback to users regarding strength of possible offers on individualized real estate listings. The system as described incorporates information from a plurality of models, including an automated valuation model (AVM), a time-to-pending model, and an offer distribution model. Simulations of offers made within a range relative to a listing price are assessed and metrics relative to potential offers are precalculated. In response to receiving a set of particularized offer parameters from a user device, either an overall offer strength score or one or more offer probabilities may be provided for display in a user interface at a user device.

As noted above, technical challenges in real estate offer analysis systems arise from the need to process and serve complex probabilistic predictions for millions of concurrent property listings while maintaining accuracy and responsiveness. Traditional approaches using single global models or purely batch processing systems face significant limitations in providing timely, listing-specific insights. By contrast, and in accordance with example embodiments described herein, a combination of precalculated metrics and realtime assessment of particular offer parameters enables realtime feedback to users regarding a strength of a particular offer.

The offer strength analysis and feedback system of the present disclosure has a number of technical advantages. Overall, the system described herein enables realtime responsiveness for user interactions while maintaining computational efficiency and prediction accuracy across millions of concurrent listing models.

Specifically, a hybrid approach is utilized in example embodiments in which certain metrics are precalculated (e.g., on a daily or weekly basis, or as needed), and offer strength values may also ber precomputed for realtime delivery. In some instances, the offer-specific metrics are calculated or updated in realtime as well. Such an arrangement provides optimization of computational resources by balancing data freshness with performance and responsiveness. In some specific examples of this approach, probabilities are stored as ratios in a grid structure representing outcome probabilities across a range of prices relative to a listing price; these ratios may be quickly translated to success probabilities in response to receiving offer parameters; this provides a compact manner of storage while maintaining accuracy.

In particular, accuracy is ensured by use of individual models for each listing, which capture listing-specific nuances through use of the AVM associated with that listing. Furthermore, integration of multiple component models, and use of simulations across probability distributions of offers over time, ensures that realistic acceptability rates are Additionally, as changes are made to listings (e.g., adjustment of listing details, listing price, and the like), the hierarchical model structure of the present application provides an efficient manner of updating probability calculations by using interpolation among existing data points.

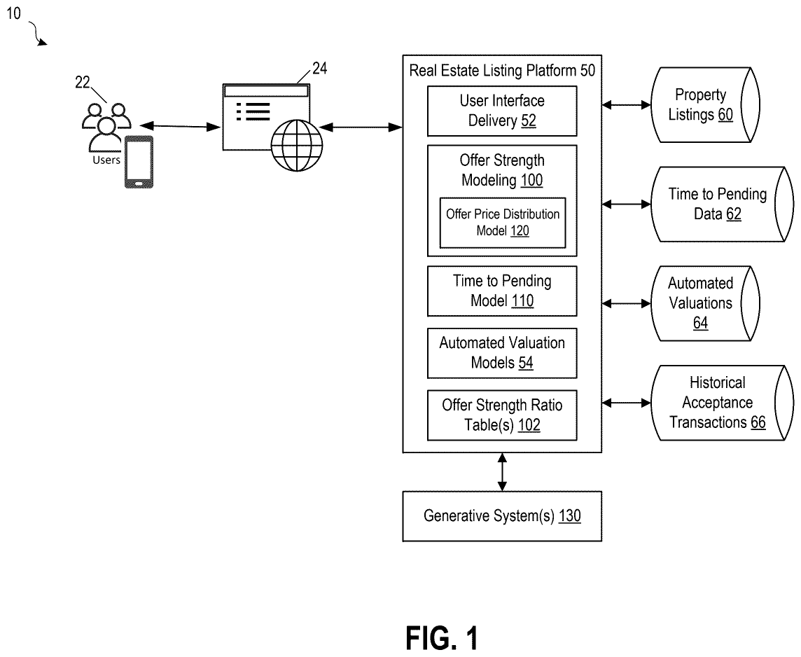

FIG. 1 is a system architecture diagram illustrating an environment 10 in which aspects of a real estate offer strength modeling system may be implemented. In some embodiments, the environment 10 corresponds to a real estate listing service accessible via a website and/or mobile application to view real estate listings across a wide geographical area (e.g., within multiple metro areas, and across a country or continent). In some examples, over a million real estate listings may be maintained separately and concurrently for access by users.

In the example shown, the environment 10 depicts an arrangement in which a plurality of users 22 may access a real estate listing platform 50 via a user interface 24, which as noted below may be implemented with formatting for use in either a website or mobile application delivery form. In general, the users 22 may search for or browse real estate listings via the user interface 24, as well as access a variety of other services made available by the real estate listing platform, such as financing, connecting with real estate agents, and the like.

In this example, the users 22 may view, within the user interface 24, a listing price for each of a plurality of viewed listings. The user interface 24 may be generated at the real estate listing platform 50 via a user interface generation component 52, such as a web server or application server. Included in the user interface 24, the users 22 may be presented an estimated valuation for the properties subject to the listings, which may be made available via an automated valuation model (AVM) 54 made available via the real estate listing platform 50. The AVM 54 generates an automated, estimated valuation for each property listing hosted by the real estate listing platform 50 based on a variety of characteristics of the property, as well as of the geographical region at which the property is located. This may include, for example, specific property features identified in a textual description of the property provided in the property listing, as well as characteristics of the property that may be apparent in images included in the property listing. Example models and data that may be used by AVM 54 are described in at least U.S. Pat. Nos. 9,605,704, 10,896,449, and 11,727,449, the disclosures of each of which are incorporated by reference in their entireties.

In the example shown, the real estate listing platform 50 has access to, and stores, a variety of types of data. The data includes, e.g., property listings 60, time to pending data 62, automated valuations 64, and historical acceptance transactions 66. The property listings 60 can include, e.g., a list price and price change history, days on the market, property features including home size, lot size, and number of bedrooms; price changes, location information including latitude and longitude, region identifiers and zip code data, and one or more images of various locations at the property described in the listing.

The time to pending data 62 includes, in some instances, time to pending predictions and probabilities for listings, historical pending status timelines (e.g., on a region-specific level of granularity), and other market level statistics, such as median days pending by region, percentages of homes that go pending over the listing price, property-specific features affecting time-to-pending, market condition indicators, and price change history. The time to pending data 62 may also include timing metrics such as duration from listing to offer submission, time periods between offer review and acceptance/rejection, and overall time from listing to pending status.

The automated valuations 64 include, for example, estimates that predict what a home will sell for if sold today, as derived from the AVM 54. The automated valuations may be set on a per-property basis and regenerated periodically (e.g., daily or weekly) based on updates to market conditions, updated sales transactions, and the like.

The historical acceptance transactions 66 include observed offer prices and acceptance data used to model offer distributions, as well as transaction data showing when sellers accepted or rejected offers. Accepted offers may be obtained from home sales transactions, while rejected offer data may be received at the real estate listing platform (e.g., when the platform is used as an agent for such sales). Additional data regarding what other offers were made may also be available. This historical acceptance data may be used to inform certain models (e.g., a kernel density estimator) useable to model offer price distributions for a particular listing, and may also be useable by automated valuation models (AVM) 54. Additionally, the historical acceptance transactions 66 inform historical patterns of seller acceptance behavior that are useable to validate modeling regarding propensity for a seller to accept or reject particular offers.

In the example shown, the real estate listing platform 50 includes an offer strength modeling system 100. The offer strength modeling system 100 may receive offer parameters in association with a particular listing and generate feedback (e.g., displayable via the user interface 24) regarding the strength of the offer. Strength of the offer may correspond to an overall strength indicator for the offer, or may correspond to a plurality of metrics indicative of a likelihood of acceptance, rejection, or outbid likelihood. The offer strength modeling system 100 utilizes outputs of a time to pending model 110 and implements an offer price distribution model 120.

In the example shown, the time to pending model 110 generates time to pending estimates for a given listing. Time to pending estimates correspond to an average time from listing to pending status for a given property, and are based on property-specific factors that might indicate the desirability of the property, as well as market-specific factors indicating the overall likelihood of sales in a given geographic region.

In the example shown, the offer price distribution model 120 generates a distribution of offer prices over time. Specifically, the offer price distribution model generates a set of offer prices within a range around the listing price (e.g., from 80% to 120% of the listing price), with likely offers grouped based on market conditions and property conditions. The offer price distribution model 120 may utilize automated valuations from the AVM 54 as well as time to pending estimates from the time to pending model 110 to generate specific offer distributions (e.g., a greater number of offers below pending as time goes on and a property remains on the market a longer time, or based on slower closing rates in a particular geographic market).

Overall the offer strength modeling system 100 uses the automated valuations generated by the AVM 54, the time to pending estimates from the time to pending model 110, and offer price distributions generated from the offer price distribution model 120 in a hierarchical manner to generate simulations of possible outcomes across the offer price distribution. The simulations may result in statistical likelihood of a variety of outcomes, including a likelihood that a particular offer is rejected or outbid, or a likelihood that an offer is successful. These likelihoods are generated based on outcomes at a particular time (e.g., based on how long the listing has remained active), and relative to the automated valuation and listing price.

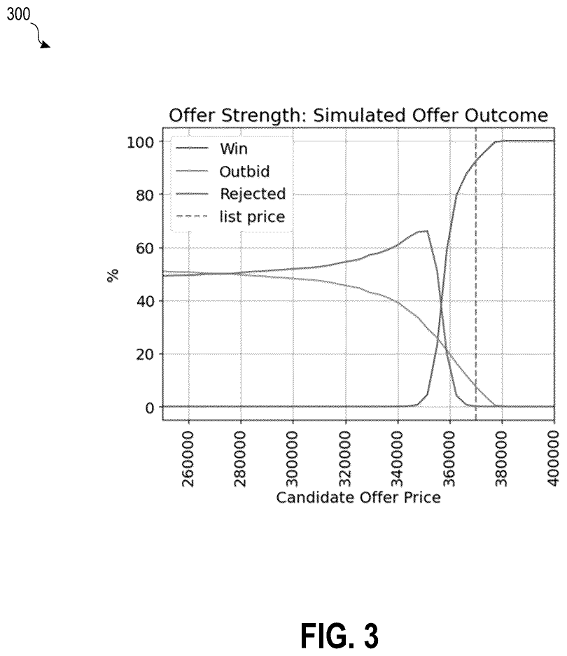

In some instances, to enable realtime offer feedback, the offer strength modeling system 100 precomputes particular metrics associated with possible offers associated with a listing, and stores those precomputed metrics in offer strength ratio tables 102. The offer strength ratio tables 102 store a plurality of offer strength metrics, including, for example, a probability of offer acceptance, a probability of being outbid, and a probability of offer rejection. Relationships among such metrics are illustrated in an example shown in FIG. 3. The precomputed metrics may be stored in the offer strength ratio tables 102 as ratios relative to an asking price, and may be recomputed periodically (e.g., daily or weekly). Because the offer strength ratios that are stored are based on, e.g., the automated valuations and time to pending data, in some instances such offer strength ratios are recalculated daily. However, to avoid having to recompute a possible offer strength for every possible price or set of offer terms, the above-described models identify and utilize likely offer price distributions to determine a likelihood of success of an offer across a range of possible offer prices.

In some instances, additional information regarding offer strength or market conditions are desired to be provided to a user 22 via the user interface 24, in addition to the offer strength assessment provided by the offer strength modeling system 100. In such instances, market details and statistics, such as average time to pending in a given real estate market, average list price to closing price comparisons, and the like, may be presented, alongside guidance regarding how a user may improve his or her offer. Such details may be generated at the offer strength modeling system 100; in alternative implementations, one or more external or additional systems, such as generative systems 130, may be called to create textual explanations of market conditions for display alongside the offer strength indicators. Such generative systems 130 may be integrated with the real estate listing platform 50 or communicatively accessible from that platform to receive requests from and provide supplemental content to the platform for display.

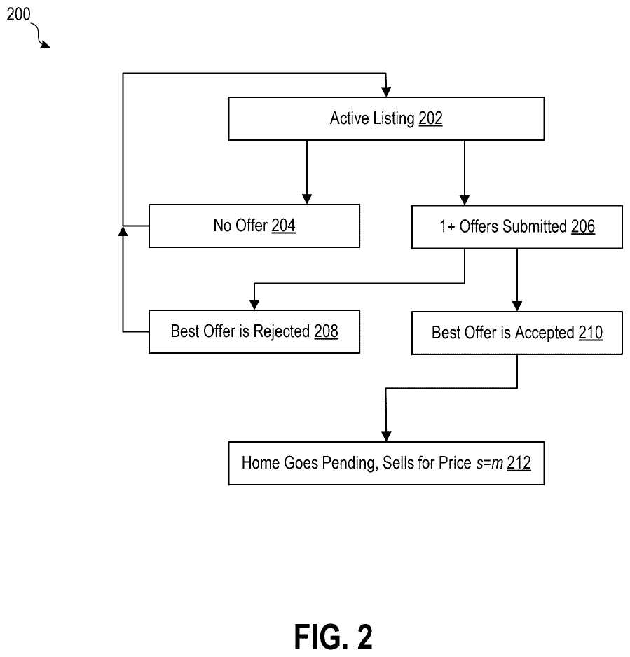

FIG. 2 is a flow diagram illustrating a model framework 200 for a real estate property offer lifecycle, in accordance with an example implementation of the present disclosure. The model framework 200 describes the latent model assumed behind a given listing. The model framework 200 may be utilized and re-estimated at each time step (e.g., daily) to ensure it is up to date.

In the example shown, an active listing 202 is pending at a particular time step. The active listing either receives no offers 204, or receives one or more offers 206. If no offer is received, the active listing 202 remains pending through to a next time step. If one or more offers is received, either a best offer is rejected 208, or the best offer is accepted 210.

In general, the model framework 200 may be realized as a mathematical model that is refit relative to each listing and each time period. The model may be mathematically represented in terms of a number of offers, offer prices, an offer set, a best offer price, and a likelihood of offer acceptance as follows:

$$Number of Offers : R \sim Poisson ( λ )$$

$$Offer Price : 0 \sim Empirical Offer Density$$

$$Offer set : {O}_{r}^{′} = \{ {o}_{1} , {o}_{2} , … {o}_{r} \} for a draw r from R and {o}_{i} independent draws from O$$

$$Best Offer Price : M / r = SellerPreference ( {O}^{′} \vert r )$$

$$Offer Acceptance : A \sim Bernouilli ( {p}_{m} )$$

In the above mathematical distribution, the number of offers received is derived from a Poisson distribution, providing the probability of an offer being received a particular number of times within a predetermined time interval. The offer acceptance probability is modeled as a Bernoulli distribution, which provides a probability of a binary event occurring (acceptance or rejection).

FIG. 3 is a graph 300 showing simulated offer outcomes across different candidate offer prices for a particular listing, in accordance with an example embodiment. The graph 300 illustrates a simulated set of outcomes for a listing having an offer price of $370,000, where the listing has a predetermined set of attributes and is in a particular geographic area. In this example, the graph 300 shows three outcome probabilities-a probability that, at each price point, an offer results in a winning bid, a probability that, at each price point, a bid is rejected and a probability that, at each price point, a bid is outbid. As seen in the graph 300, at offer prices far below the listing price (and presumably below an estimated value of the listing), a win probability is very low, while a probability of either being outbid or outright rejected are close to even (representing the cases where there is another bid or not). As prices approach a value for the property, the probability of a win increases dramatically, and the probability of being outbid drops (resulting in an increase in probability of rejection). As offer prices increase to exceed the listing price, the probability of a win approaches 100% while the probability of either being outbid or rejected drop significantly; in this instance, a seller is likely to accept an offer, and the probability of being outbid represents the circumstances in which the offering party would not win (i.e., have their offer accepted).

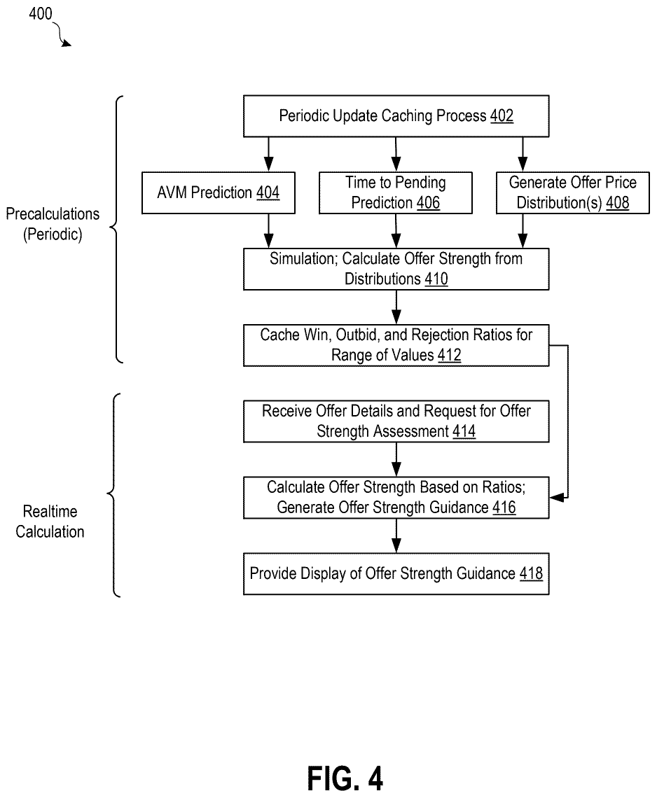

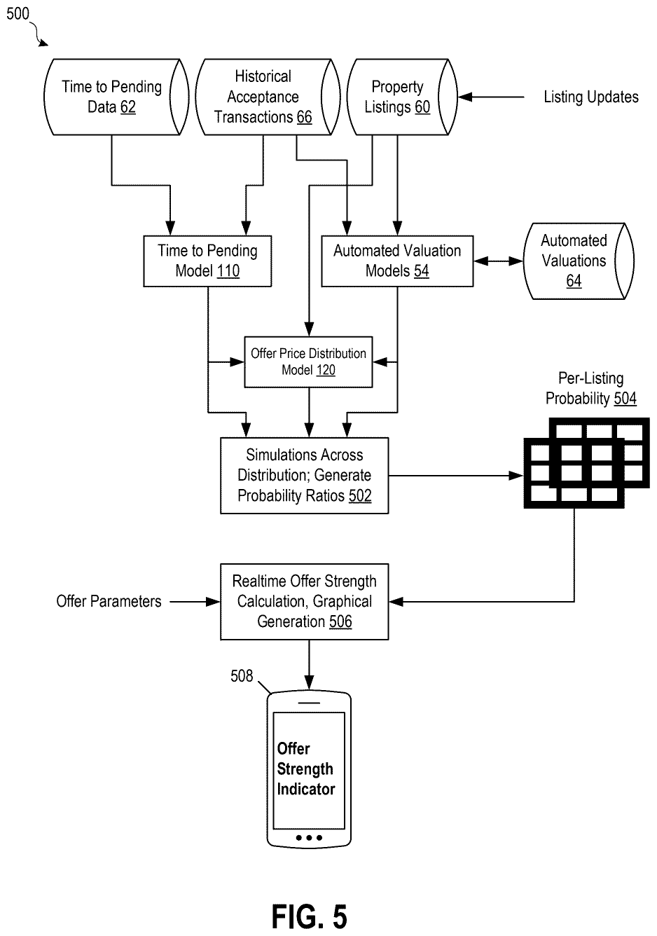

Referring now to FIGS. 4-5, a process flow diagram and a data flow diagram are provided, illustrating methods and systems for modeling and delivering offer strength assessments. Such assessments are made in realtime or near-realtime in response to receipt of user input of offer parameters; as such, aspects of the methods and systems described herein involve a combination of precomputed characteristics of a real estate property listing and potential offers that might be received in association with such a listing, as well as realtime final calculations of overall offer strength that enable quick lookup, calculation, and display of offer strength metrics.

FIG. 4 is a process flow diagram for a method 400 of modeling offer strength, showing a periodic updating process and real-time calculation components in accordance with an example embodiment. In general, the method 400 includes a periodic update caching process and a real-time calculation process. The periodic update process performs precalculations that are cached for later use, while the real-time process handles immediate offer strength assessments.

In the example shown, the method 400 includes initiating a periodic recalculation process (step 402). This may occur daily, hourly, or on different cadences for different ones of the precalculation processes. In the example shown, precalculations include generation of automated valuation model (AVM) predictions (step 404), generation of time to pending predictions (step 406), and generation of offer price distributions (step 408).

Generation of AVM predictions at step 404 includes generation of a valuation estimate for each property that may be subject to a listing. In some instances, valuations are generated for more properties than those for which listings exist in a given geographic area; such valuations may be generated based on past sales, tax information, known characteristics of the property from past listings, and the like. In examples, generation of AVM predictions involves creation of new predictions or updating of predictions across a large geographic area including a plurality of sub-regions, each of which may have separate housing market sales dynamics. The AVM predictions are based, in part, on details of the property, as well as details regarding sales trends in the specific sub-region or geographic area where the property is located.

Generation of time to pending predictions at step 406 involves use of a time to pending model, which may be implemented as a boosted tree model implemented in a survival analysis context. This model calculates listing-specific probability distributions for pending status across multiple time periods while incorporating listing-specific features including property characteristics and market conditions. The time to pending model may generate, for example, probabilities of a listing going pending at different time intervals (1 day, 2 days, 7 days, 10 days, etc.), and uses survival analysis techniques to predict how long until a property goes pending. Survival analysis may involve various property features, including properties of the home, as well as properties of the listing (time on market, price changes), and market conditions specific to the listing location. The time to pending predictions may be regenerated either periodically to reflect changes in time-dependent factors, or in realtime when triggered by listing updates (e.g., price changes and the like).

Generation of offer price distributions at step 408 includes use of an offer price distribution model, for example implemented as a kernel density estimator, to model complete offer price distributions (rather than, e.g., point estimates). Although a kernel density estimator is used in some examples, in alternative implementations, neural networks or boosted tree approaches may be used as well or in the alternative.

The generation of an offer price distribution uses time on market as a factor, with homes on the market longer tending to get lower offers and newer listings testing to receive higher offers. The offer distribution generation generates a set of offers over a range of prices between, e.g., 80% and 120% of a listing price. While some implementations focus on use of time to pending effects, in some other implementations, other factors may be considered as well, including properties of the home that is the subject of the listing, market conditions, or other listing features.

Based on the AVM predictions, time to pending predictions, and offer price distributions for each property, a set of simulations may be executed for each property (step 410). In example implementations, the set of simulations may be performed according to a Monte Carlo analysis that fits the offer distribution that is generated for a particular listing. The Monte Carlo simulation process for calculating offer strength probabilities works by creating a grid structure for each property listing, with each grid point in a cached ratio structure (spanning the 80-120% of listing price), the simulation executes approximately 1000 Monte Carlo iterations. The simulations use inputs from the three component models-Automated valuation model (AVM) estimates, time-to-pending predictions from the time to pending model, and offer distributions generated by the kernel density estimator. In each simulation iteration, potential competing offers are drawn from the offer distribution, and seller acceptance parameters consistent with the AVM estimates are evaluated. A determination is made as to whether the offer wins, is outbid, or rejected based on the hierarchical model framework of FIG. 2. The system runs these simulations within a fitted system that assumes sellers are more likely to accept offers than not (since they have listed their home for sale). This assumption helps estimate the average acceptance rate over the whole process, including cases with multiple offers or low/high offers.

These simulation results are then converted to offer strength indicators, represented as a set of probabilities such as (1) win probability, (2) outbid probability, and (3) rejection probability. These probabilities are then cached (step 412) in memory across the grid of offer prices, for later use.

A realtime calculation process may be initiated by receipt of offer details and a request for an offer strength assessment (step 414). This may occur in response to, e.g., a user submitting an offer price into a user interface, for example as seen in FIG. 1. The user interface may include, e.g., a user-entered offer price, a slider showing change of offer strength in response to offer price, or the like. In response thereto, the method 400 includes calculating final offer strength values in realtime, e.g., based on the cached probabilities at offer ratios (step 416). Specifically, when offer details are received, the system will retrieve the relevant cached ratios from the grid-based structure, and identify adjacent grid points to the specific offer amount being evaluated. A ratio-based interpolation between the cached values may be performed to determine a more precise probability for the particular offer amount. The interpolated ratios may then be converted into one or more offer strength scores. The one or more offer strength scores may include, e.g., a win probability, an outbid probability, and a rejection probability, as noted above.

Once the offer strength values are calculated, offer strength guidance may be provided (step 418). Providing offer strength guidance may include, e.g., converting the calculated probabilities into a displayable format. It may also include generating an overall offer strength score based on whether a likelihood of winning is within particular thresholds.

In some instances, providing offer strength guidance may include, e.g., presentation of various types of relevant market context alongside the offer strength guidance. The relevant market context may include, e.g., average days on the market for listings in a particular geographic area, list-to-sale price ratios, and other market temperature indicators. In some instances, additional narrative explanation may be provided in the user interface, e.g., as may be generated from the above data by one or more generative systems 130 as noted above. For example, narrative explanations of market conditions or explanations regarding the particular offer strength metric may be generated by such a system, and provided for display via a user interface to a user device.

In general, referring to the method 400, the process of performing precalculation while interpolating offer strength from a grid of precomputed values allows the system to provide immediate probability calculations without requiring new simulations at values not previously calculated. Furthermore, coordinated update lifecycles may be provided in response to market factors or listing-specific changes being made for a particularized listing.

Still referring to FIG. 4 generally, although a particular arrangement of precalculated and realtime components are provided, in alternative solutions, a greater amount of the overall process may be performed in realtime. For example, in some implementations, the simulations and updating of cached values may be performed in realtime, with the model-based predictions being maintained as offline/precomputed portions. In such an arrangement, the simulations and regeneration of cached grid values may be performed in realtime. Such an arrangement may be beneficial in circumstances where greater realtime computation capabilities are available, and less memory is available for creation/updating of the precomputed grid values.

In either implementation, the methodology reflected in FIG. 4 illustrates coordinated updates between the periodic and real-time paths to ensure cached values remain current while supporting approximately one million concurrent listing models. This hybrid approach optimizes computational resources by balancing data freshness with performance requirements.

FIG. 5 is a data flow diagram 500 according to an example implementation of the present disclosure. The data flow diagram 500 illustrates the interaction between time to pending data, property listings, automated valuation models and the offer strength calculation components to generate offer strength indicators as probabilities at offer ratios, according to example embodiments.

In the example shown, data inputs including property listings 60, time to pending data 62, automated valuations 64, and historical acceptance transactions 66 are utilized. In particular, the time to pending data 62 and historical acceptance transactions 66 are inputs to a time to pending model 110, as described above, which implements survival analysis techniques to generate pending status predictions. The property listings 60, and listing updates, are provided to AVMs 54, which generate the automated valuations 64. Additionally, the offer price distribution model 120 uses a kernel density estimation to model, on a per listing basis on each of the listings 60, offer distributions around asking prices as noted above. As described above, the modeling components as described herein generate predictions in a set of batched or offline processes, and may occur daily, weekly, or upon receipt of updates to relevant data (e.g., pending data, transaction acceptance data, or listing updates).

Outputs from the AVM 54, the time to pending model 110, and the offer price distribution model 120 are used in a simulation system 502. This simulation occurs, for each listing, a number of times (e.g. over one thousand iterations to generate a representative set of data points across the offer distribution for each listing). The outcomes of these simulations result in probabilities of a successful offer, an outbid offer, or a rejected offer, at each of a set of prices across a range spanning across the list price (e.g., from 80% to 120% of the list price). These per-listing probabilities are stored in a grid-based cache structure 504, which stores 40 separate price points across that range and ratios at each price point.

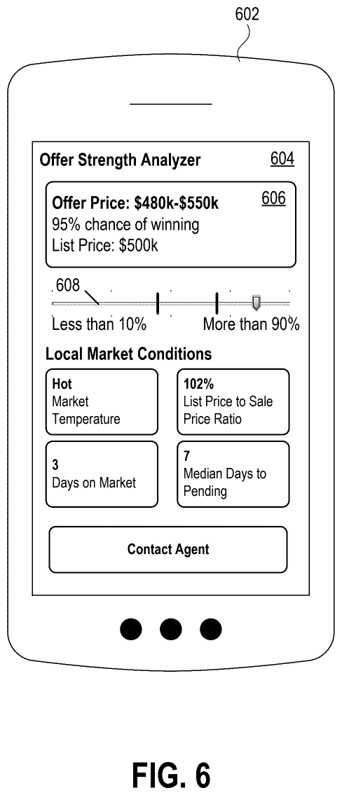

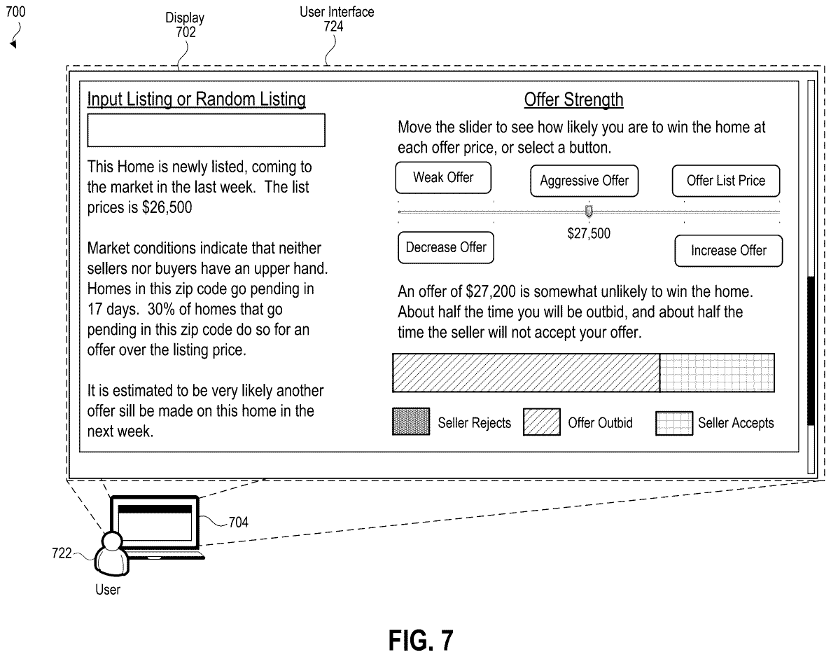

When offer parameters are received at a user interface (e.g., user interface 24 described above, or the user interfaces of FIGS. 6-7 noted below), a realtime calculation component 506 will access the grid-based cache structure 504. An input set of offer parameters, including an offer price, will be compared to the ratios included in the grid. If the offer price is between two stored grid values, ratios associated with the offer price may be interpolated between the two grid values (e.g., by linear interpolation). Accordingly, a final set of ratios for the particular offer may be generated. These ratios may be converted to probabilities and presented via an offer strength indicator 508 presented within a user interface to a user in response to receipt of the offer parameters.

In the data flow diagram 500, it is noted that listing updates may trigger regeneration of automated valuations and various model components, e.g., of the AVM 54, time to pending model 110, and offer price distribution model 120. These may be batch processed in response to such updates. In some instances, this batch processing may occur in response to receipt of an updated list price, so that the time between a change in a listing and updates to the offer strength calculations also being updated is minimized. Additionally, while in some instances the simulation component 502 may be triggered and executed as part of this batch process, in other implementations, the simulation component may be utilized in realtime on the basis of model outputs. In any such implementation, the realtime calculation component 506 executes in response to offer parameters being received, thereby enabling immediate feedback regarding offer strength to the user.

FIG. 6 depicts an example user interface 600 of an offer strength analyzer showing offer price range, win probability, and local market conditions including market temperature and days on market metrics. The user interface 600 is illustrated as being presented on a mobile device, for example either in a mobile browser or mobile application. The user interface 600 may be presented as a possible embodiment of the user interface 24 of FIG. 1.

In the example shown, the user interface 600 includes an example implementation of an offer strength analyzer 602 that provides real-time offer strength feedback and market context to users. As illustrated, the interface includes an offer price display section 604 that shows both the current offer amount ($480 k-$550 k) and the list price ($500 k), along with a prominent indicator showing a computed likelihood of winning the home at the selected offer amount. In the example shown, the probability visualization includes a slider bar 608 that shows movement of an offer price within the overall offer price range indicator 606. The calculated offer strength is depicted alongside the slider bar 608, and indicates a likelihood of success ranging from “Less than 10%” to “More than 90%”, providing users with an intuitive representation of their offer strength relative to the listing price.

In addition to the strength of a particular offer, the user interface 600 displays a number of additional fields that provide additional context to a user. For example, the user interface 600 may present local market conditions through several key metrics, including a market temperature indicator (indicating a “Hot” market temperature) showing current market dynamics. Additionally, a list to sale price ratio indicates typical transaction outcomes, and a number of days on the market for the specific property are shown. This is contrasted with a median number of days on the market to pending in the local geographic area, showing the relative “age” of the listing. In the example shown, a contact agent option is also included in the interface, allowing users to connect with local real estate professionals for additional guidance on creating offers.

FIG. 7 shows another user interface 700, according to an example implementation. The user interface 700 may be presented to a user 722 via a user interface 724 displayable on a display 702 of a computing device 704. As illustrated, the computing device 704 may be a laptop or desktop computing device; however, analogous information and indicators may be presented on a mobile device, such as a phone or tablet.

In the example shown, the user interface 724 presents input controls including a field enabling entry of a particular listing, or selection of a random listing, for analysis. Below this, the system displays key listing information including whether the home is newly listed and its current list price. The interactive features in the user interface 724 include a slider interface for adjusting an offer amount, as well as preset buttons for selecting a “weak offer” price point, an “aggressive offer” price point, and an “offer list price” price point. By selecting these options, the slider bar may move and the offer strength analysis is updated. In addition, a “decrease offer” and an “increase offer” button provide decrement/increment selections to move the slider bar, thereby adjusting a predetermined amount and updating, in realtime, the offer strength analysis presented alongside the offer.

In the example shown, a textual section provides market balance indicators, showing whether sellers or buyers have advantages, and includes a plurality of metrics, such as typical pending timeline metrics (17 days in this example), percentage of homes going pending above list price (30%), and probability estimates for receiving competing offers. Text descriptions may be generated at the real estate listing platform 50, or at a separate generative language model (e.g., generative systems 130 of FIG. 1) which may generate, in near-realtime, text including such metrics for display and explanation to a user.

In addition to the market balance indicators, as a user adjusts the slider or controls, realtime probability updates are provided in a bar chart graphical display. The graphical chart shows the relative percentages of success and other outcomes, i.e., whether an offer is likely to win the home, a probability of being outbid, and/or likelihood of seller rejection.

In use, as the user adjusts the offer, the realtime probability graphics are updated quickly based on the ratio-based caching system described above, which allows immediate updates as users interact with the controls while maintaining computational efficiency across approximately one million concurrent listing models. The interface presents these complex probability calculations in an intuitive visual format that helps users understand both their offer strength and relevant market conditions.

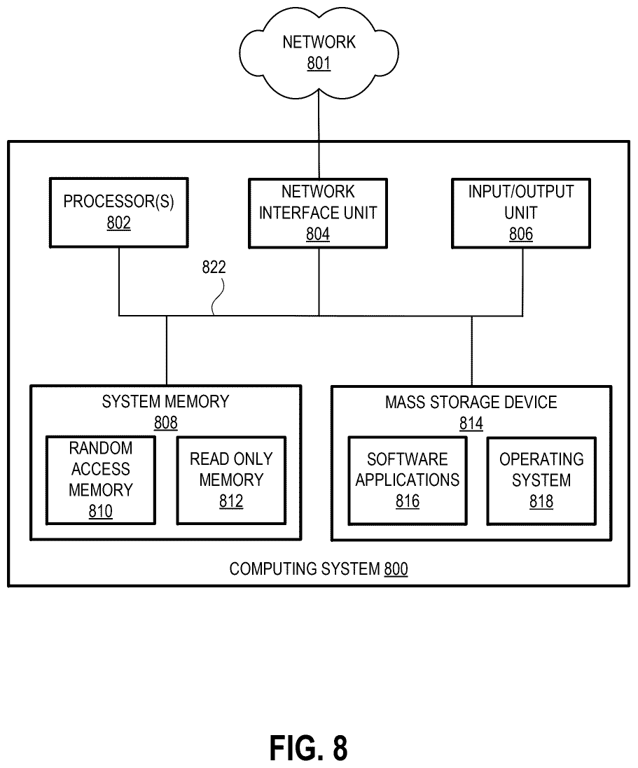

FIG. 8 is a block diagram illustrating an example computing system 800 with which aspects of the offer strength modeling system may be implemented. One or more aspects of the computing system 800 can be used to implement the systems described herein, store instructions described herein, and perform operations described herein.

In the embodiment shown, the computing system 800 includes one or more processors 802, a system memory 808, and a system bus 822 that couples the system memory 808 to the one or more processors 802. The system memory 808 includes RAM (Random Access Memory) 810 and ROM (Read-Only Memory) 812. A basic input/output system that contains the basic routines that help to transfer information between elements within the computing system 800, such as during startup, is stored in the ROM 812. The computing system 800 further includes a mass storage device 814. The mass storage device 814 is able to store software instructions and data. The one or more processors 802 can be one or more central processing units or other processors.

The mass storage device 814 is connected to the one or more processors 802 through a mass storage controller (not shown) connected to the system bus 822. The mass storage device 814 and its associated computer-readable data storage media provide non-volatile, non-transitory storage for the computing system 800. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 800.

According to various embodiments of the invention, the computing system 800 may operate in a networked environment using logical connections to remote network devices through the network 801. The network 801 is a computer network, such as an enterprise intranet and/or the Internet. The network 801 can include a LAN, a Wide Area Network (WAN), the Internet, wireless transmission mediums, wired transmission mediums, other networks, and combinations thereof. The computing system 800 may connect to the network 801 through a network interface unit 804 connected to the system bus 822. It should be appreciated that the network interface unit 804 may also be utilized to connect to other types of networks and remote computing systems. The computing system 800 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the computing system 800 can store software instructions and data. The software instructions include an operating system 818 suitable for controlling the operation of the computing system 800. The mass storage device 814 and/or the RAM 810 also store software instructions, that when executed by the one or more processors 802, cause one or more of the systems, devices, or components described herein to provide functionality described herein. For example, the mass storage device 814 and/or the RAM 810 can store software instructions that, when executed by the one or more processors 802, cause the computing system 800 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures, systems, and methods shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computer-implemented method for determining real estate offer strength, comprising:
receiving, by one or more processors, listing data for a real estate property;
generating, by the one or more processors:
estimated values for each of a plurality of real estate properties including the real estate property by a first model comprising an automated valuation model (AVM);
time-to-pending predictions for the plurality of real estate properties including the real estate property by a second model comprising a time-to-pending model; and
an offer probability distribution for the plurality of real estate properties including the real estate property at a third model comprising an offer distribution model;
combining, by the one or more processors, outputs of the first, second, and third models into a hierarchical framework by:
estimating seller acceptance parameters consistent with the estimated values; and
generating offer probability distributions aligned with the time-to-pending predictions and the estimated values;
performing, by the one or more processors, a series of simulations using the hierarchical framework including the offer probability distributions and seller acceptance parameters to determine, for each property, a plurality of probabilities including:
a probability of offer acceptance;
a probability of being outbid; and
a probability of offer rejection; and
caching, in memory, results of the series of simulations for each property in advance of receiving offer parameters from a user device in a cache structure indexed by candidate offer prices for the real estate property, the results including, for individual ones of the candidate offer prices, values representative of the probability of offer acceptance, the probability of being outbid, and the probability of offer rejection, wherein the results are reusable for offer strength calculation requests from a plurality of user devices;
in response to receiving a set of offer parameters, including an offer price, associated with the real estate property from the user device, calculating an offer strength based on the set of offer parameters and the cached results of the series of simulations by retrieving the cached results from the cache structure for the offer price, wherein calculating the offer strength includes:
responsive to the offer price being between a first cached result and a second cached result in the cached results, interpolating between the first cached result and the second cached result to determine the offer strength; and
providing, by the one or more processors, an indication of offer strength for display via a user interface in association with the real estate property.

2. The computer-implemented method of claim 1, further comprising regenerating, by the one or more processors, the hierarchical framework in response to listing updates comprising price changes and time-on-market changes for the real estate property.

3. The computer-implemented method of claim 1, wherein the offer distribution model comprises a kernel density estimator, the kernel density estimator being configured to model offer probability distributions across a range of offer prices.

4. The computer-implemented method of claim 1, wherein generating time-to-pending predictions comprises:
implementing a boosted tree model in a survival context;
calculating listing-specific probability distributions for pending status across multiple time periods; and
incorporating listing-specific features including property characteristics and market conditions.

5. The method of claim 4, wherein the boosted tree model implements a survival analysis specific to the real estate property.

6. The computer-implemented method of claim 1, wherein fitting model parameters specific to listing characteristics comprises:
analyzing property features of an individual listing;
incorporating market conditions specific to a listing location; and
evaluating listing-specific factors including time on market and price changes.

7. The method of claim 1, further comprising:
calculating offer strength values across a grid of offer prices determined in accordance with the offer probability distribution ranging from a predetermined percentage below a listing price to a second predetermined percentage above the listing price; and
wherein the cache structure comprises a grid-based cache structure having a plurality of predetermined price points, the results of the series of simulations being stored at each predetermined price point for retrieval in response to user input of a particular offer price.

8. The method of claim 7, wherein caching the offer strength values includes storing the offer strength values as ratios.

9. The method of claim 1, further comprising:
automatically updating the time-to-pending predictions generated by the second model on a daily basis; and
automatically updating the offer probability distribution generated by the third model on a daily basis.

10. The method of claim 1, wherein the series of simulations generates, for each real estate property and across a range of prices, the probability of offer acceptance, the probability of being outbid, and the probability of offer rejection, the series of simulations including, for each real estate property, a plurality of Monte Carlo simulations performed across an offer probability distribution for that real estate property.

11. The method of claim 1, wherein the series of simulations are re-executed in realtime in response to receipt of updated offer parameters.

12. A system for providing realtime real estate offer strength feedback based on offer parameters associated with a real estate listing, the system comprising a server system that includes:
one or more processing units;
a memory communicatively coupled to the one or more processing units storing an automated valuation model, a time-to-pending model, and an offer distribution model, the memory further storing instructions which, when executed, cause the one or more processing units to:
receive listing data for a real estate property;
generate estimated values for each of a plurality of real estate properties including the real estate property by the automated valuation model (AVM);
generate time-to-pending predictions for the plurality of real estate properties including the real estate property by the time-to-pending model; and
generate an offer probability distribution for the plurality of real estate properties including the real estate property at the offer distribution model;
combine outputs of the AVM, the time-to-pending model, and the offer distribution model into a hierarchical framework by estimating seller acceptance parameters consistent with the estimated values and generating offer probability distributions aligned with the time-to-pending predictions and the estimated values;
perform a series of simulations using the hierarchical framework including the offer probability distributions and seller acceptance parameters to determine, for each property, a plurality of probabilities including a probability of offer acceptance, a probability of being outbid, and a probability of offer rejection; and
cache, in the memory, results of the series of simulations for each property in advance of receiving offer parameters from a user device in a cache structure indexed by candidate offer prices for the real estate property, the results including, for individual ones of the candidate offer prices, values representative of the probability of offer acceptance, the probability of being outbid, and the probability of offer rejection, wherein the results are reusable for offer strength calculation requests from a plurality of user devices;
in response to receiving a set of offer parameters, including an offer price, associated with the real estate property from the user device, calculate an offer strength based on the set of offer parameters and the cached results of the series of simulations by retrieving the cached results from the cache structure for the offer price, wherein to calculate the offer strength includes to:
responsive to the offer price being between a first cached result and a second cached result in the cached results, interpolate between the first cached result and the second cached result to determine the offer strength; and
provide an indication of offer strength for display via a user interface in association with the real estate property.

13. The system of claim 12, wherein providing the indication of offer strength for display comprises providing an overall probability of offer success.

14. The system of claim 13, wherein the system is further configured to provide one or more market conditions indicators along with the one or more determined probabilities for display.

15. The system of claim 13, further comprising a user device communicatively connected to the server system, the user device being configured to display the user interface.

16. The system of claim 15, wherein the user interface includes an interactive slider, and wherein, in response to adjustment of an offer price amount, the system is configured to generate an updated set of determined probabilities in realtime and provide the updated set of determined probabilities for display via the user interface.

17. The system of claim 12, wherein the time-to-pending model comprises a boosted tree model including a survival analysis specific to the real estate property.

18. The system of claim 12, wherein the offer distribution model comprises a kernel density estimator, the kernel density estimator being configured to model offer probability distributions across a range of offer prices.

19. The system of claim 12, wherein the series of simulations generates, for each real estate property and across a range of prices, the probability of offer acceptance, the probability of being outbid, and the probability of offer rejection, the series of simulations including, for each real estate property, a plurality of Monte Carlo simulations performed across an offer probability distribution for that real estate property.

20. A computer-readable storage medium storing computer-executable instructions thereon which, when executed by a computing system, cause the computing system to perform a method for determining real estate offer strength, comprising:
receiving, by one or more processors, listing data for a real estate property;
generating, by the one or more processors:
estimated values for each of a plurality of real estate properties including the real estate property by a first model comprising an automated valuation model (AVM);
time-to-pending predictions for the plurality of real estate properties including the real estate property by a second model comprising a time-to-pending model; and
an offer probability distribution for the plurality of real estate properties including the real estate property at a third model comprising an offer distribution model;
combining, by the one or more processors, outputs of the first, second, and third models into a hierarchical framework by:
estimating seller acceptance parameters consistent with the estimated values; and
generating offer probability distributions aligned with the time-to-pending predictions and the estimated values;
performing, by the one or more processors, a series of simulations using the hierarchical framework including the offer probability distributions and seller acceptance parameters to determine, for each property, a plurality of probabilities including:
a probability of offer acceptance;
a probability of being outbid; and
a probability of offer rejection; and
caching, in memory, results of the series of simulations for each property in advance of receiving offer parameters from a user device in a cache structure indexed by candidate offer prices for the real estate property, the results including, for individual ones of the candidate offer prices, values representative of the probability of offer acceptance, the probability of being outbid, and the probability of offer rejection, wherein the results are reusable for offer strength calculation requests from a plurality of user devices;
in response to receiving a set of offer parameters, including an offer price, associated with the real estate property from the user device, calculating an offer strength based on the set of offer parameters and the cached results of the series of simulations by retrieving the cached results from the cache structure for the offer price, wherein calculating the offer strength includes:
responsive to the offer price being between a first cached result and a second cached result in the cached results, interpolating between the first cached result and the second cached result to determine the offer strength; and
providing, by the one or more processors, an indication of offer strength for display via a user interface in association with the real estate property.
